(19) United States
(12) Patent Application Publication
(10) Pub. No.: US 2026/0153171 A1
(43) Pub. Date: Jun. 4, 2026

(54) SOLIDS-CONVEYING PIPE ASSEMBLY WITH WEAR MEASUREMENT

(71) Applicant: ESSER-WERKE GMBH, Warstein (DE)

(72) Inventor: Peter SPANKE, Warstein (DE)

(21) Appl. No.: 19/122,718

(22) PCT Filed: Sep. 7, 2023
(86) PCT No.: PCT/DE2023/100664

§ 371 Date: Apr. 18, 2025

(30) Foreign Application Priority Data
Oct. 21, 2022 (DE) 10 2022 127 937.5

(51) Int. Cl. F16L 9/18; F16L 17/04; F16L 19/028; F16L 21/03; F16L 23/028; F16L 37/091

(52) U.S. Cl. CPC F16L 23/006

(57) ABSTRACT

A solids-conveying pipe assembly includes two pipe components which are coupled together at the end faces, and a signal line is incorporated which provides information regarding the state of wear of the pipe components, characterized in that a seal is incorporated between the end faces of the pipe components, or in that a spacer disk is incorporated between the end faces of the pipe components. The signal line is arranged in an at least partially circumferential configuration in the seal or in the spacer disk, and the signal line is at least partly set back outwardly, in the radial direction, behind the inner lateral surface of at least one pipe component.

### RELATED APPLICATIONS

The present application is a National Phase of International Application Number PCT/DE2023/100664, filed Sep. 7, 2023, and claims priority of German Application Number 10 2022 127 937.5 filed Oct. 21, 2022.

### FIELD

The present disclosure relates to a solids-conveying pipe assembly.

### BACKGROUND

During the fluid conveyance of solids, during the conveyance of concrete, the internal surfaces of the pipelines are subject to severe wear due to the abrasive effect of the solids. Wear resistance is able to be increased by using two-layer pipelines, with one outer pipe made of weldable steel and one inner pipe that is more wear-resistant than the other. The ends of such solids-conveying components are subject to increased wear. In the region of the transitions, turbulence occurs in the flow adjacent to the lateral surface, so that increased abrasive wear is observed here. Subsequently, pipe collars are placed on the solids-conveying component, in which wear rings are inserted.

However, wear still occurs which progresses from the inside out across the lateral surface at the pipe collar transitions or in the pipe body itself.

To be able to detect progressive wear until a critical wear state is reached, there are various solutions available, which sometimes require complex technology and/or only allow for selective conclusions to be drawn about the wear that has occurred in the pipe. From DE 198 21 637 A1, from DE 10 2005 051 767 A1 or also from DE 10 2012 108 617 A1 various possibilities are described for forming wear indicators in the pipe body and/or in the pipe collar of a solids-conveying component. These are mainly mechanical wear indicators.

If in doubt, the piping system is able to be at least partially dismantled to inspect and assess the progressive wear.

From WO 00/70326 A1 and AU 2010 100 667 A1, a wear measurement using a circumferential wire is described for a conveyor pipe. The electrical conductor is cast into an internal plastic pipe.

Furthermore, EP 3421859 B1 describes a solids-conveyor component with a wear indicator in which a signal line is integrated into a two-layer pipe collar.

Furthermore, conveying pipe assemblies are known from CA 2 982 367 A1 and CA 2 886 146 A1, in which a measurement of wear is incorporated in the seal.

### SUMMARY

The object of the present disclosure is to show a possibility of carrying out a wear measurement on solids-conveying pipes, while at the same time minimizing the associated structural design and, providing a retrofitting solution. The aforementioned object is achieved according to the present disclosure with a solids-conveying pipe assembly.

The solids-conveying assembly according to the present disclosure has two pipe components which are coupled to each other at the end faces. A signal line is integrated or incorporated, which provides information about the state of wear, i.e., the progressing state of wear on the inner lateral surface of the pipe component.

According to the present disclosure, the solids-conveying pipe assembly is characterized in that the pipe components are indirectly in contact with one another at the end faces in the axial direction with the incorporation of the signal line, wherein the signal line is set back outwardly in the radial direction behind the inner lateral surface of at least one pipe component, for example, is set back completely behind the inner lateral surface of at least one pipe component. The two end faces of the pipe components adjacent in the axial direction therefore do not lie directly against each other, but rather with the incorporation of the seal or spacer disk described below. A pipe component is a piece of pipe in the sense of the present disclosure. However, a pipe component is also able to be, for example, a pipe bend or a pipe collar.

If abrasive wear thus occurs on the inner lateral surface of the solids-conveying pipe assembly, the signal line, which is offset radially outwards, is reached with continuous abrasion. Depending on the design of the signal line, different scenarios are able to occur. For example, the signal line is able to trigger a signal when coming into contact with the solid to be conveyed, so that a wear limit is absolutely reached. The signal line is also able to be continuously severed in the case of, for example, an electrical resistance measurement and provide a percentage indication of the progressing wear. The signal line is also able to be designed as an optical signal conductor in the sense of the present disclosure. If the signal line is hit or severed, a wear signal is triggered.

According to the present disclosure, the incorporation of the signal line differs from the aforementioned references in that the signal line is not integrated or cast into a pipe component, but into a seal or spacer disk arranged between the pipe components, thus a carrier disk. This makes possible to retrofit existing solids-conveying pipe assemblies, for example, on a concrete pump or similar, with a wear indicator according to the present disclosure.

For example, when replacing individual conveyor pipe components, a carrier disk or seal is able to be incorporated so that a wear indicator is able to be subsequently provided in an existing solids-conveyor pipe assembly.

The carrier disk, for example, is a spacer disk. This is able to be made from a plastic material. The carrier disk is also able to be a disk-like seal made of a rubber-like or elastomeric sealing material. For example, the materials NBR or EPDM are able to be used here.

The individual pipe components are overlapped by an externally circumferential seal, wherein the seal extends at least partially in the axial direction and overlaps the individual pipe components. To connect two pipe components, a clamp is placed on the outside, encompassing the pipe and the seal. The seal is able to have a web that projects radially inwards. The web is then the spacer disk or carrier disk. The web is either made in one piece and made of the same material as the seal itself. However, the web is also able to be designed as a separate spacer disk. This makes possible to freely select the position, with regard to the radial direction of the seal or in the spacer disk. The signal line is then cast or integrated into the seal or spacer disk. This makes possible, considering the possibility of retrofitting, to determine the radial positioning of the signal line relatively easily during the manufacture of the seal or spacer disk. This avoids the need for structural measures in the pipe component itself. In at least one embodiment of the present disclosure, the position of the signal line is able to be freely selected and defined for different application purposes, i.e., the conveyance of different solids, so that, for example, different wear states are able to be reached on different pipe components until a critical wear state is reached.

In an alternative design variant, the pipe components are able to have a flange at respective end sides. The flange protrudes radially outwards. The pipe components are then screwed together via the flanges, for example, in the axial direction. A seal or spacer disk is also able to be used here, with the signal line again being integrated into the seal.

In at least one embodiment of the present disclosure, the signal line itself is made of an electrically conductive material, for example, a wire, of copper or another metallic electrically conductive alloy. The signal line itself is able to be further electrically insulated. In at least one embodiment of the present disclosure, the signal line is also integrated directly into the seal or spacer disk, which is made of a non-electrically conductive material, i.e., an electrically insulating material. This also eliminates the need for complex insulation measures.

In explosion-proof conveying systems, for example, using pneumatics or similar, the signal line is an optical line. No electrical energy is applied via the optical conductor, enabling explosion-free wear measurement.

In at least one embodiment of the present disclosure, multiple signal lines, for example, two, three, four, five or six signal lines, are incorporated between the pipe components at a distance from one another in the radial direction. If the respective internal signal line is destroyed by abrasive wear, the signal line closest in the radial direction forms a further control level. All signal lines emit a signal when a critical wear condition is reached. This allows the progressive wear of the pipe components to be closely monitored.

In at least one embodiment of the present disclosure, more than three pipe components are able to be coupled to one another. The coupling refers to a coupling in series. Thus, at least two coupling points are present, with a respective signal line being arranged in each coupling point according to the present disclosure. Thus, different wear states in the axial direction of the solids-conveying pipe assembly are able to be detected. In at least one embodiment of the present disclosure, individual pipe components that have reached a state of wear are able to be detected locally. In case of doubt, there is no need to replace the entire solids-conveying pipe string on a concrete pump, but only individual pipe components. The pipe components themselves are able to be pipes, but also angles or fittings, for example, pipe bends.

Multi-layer pipes, for example, two-layer pipes, are also able to be coupled to the signal line according to the present disclosure.

At least one, two, line ends then protrude radially outwards. In at least one embodiment of the present disclosure, the signal line is able to be provided with a connecting line, for example, a wired connecting line. In at least one embodiment of the present disclosure, two contact points are able to be set-up for an external measuring device, which, for example, temporarily applies a current to the contact points and thus performs a temporary discontinuous wear measurement. With a line connection, for example, continuous wear measurement is also able to be carried out, for example, in a control center system for production monitoring or connected to a mobile concrete pump for continuous monitoring during operation. However, a unit is also able to be provided that transmits signals wirelessly to a machine control system or similar, for example, the signal is able to be a GSM signal or a WLAN signal, a Bluetooth signal or similar. A unit is able to be provided that emits an acoustic and/or optical signal when the wear state is reached.

In at least one embodiment of the present disclosure, an NFC tag is able to be used so that the wear state reached is able to be read using an NFC reader, such as a mobile phone, via the NFC tag.

### BRIEF DESCRIPTION OF THE DRAWINGS

Further advantages, features, properties, and aspects of the present disclosure are the subject of the following description.

Various embodiments are shown in the schematic figures:

FIG. 1 shows a cross-sectional view through a solids-conveying pipe assembly according to a first embodiment variant of the present disclosure,

FIG. 2 shows a cross-sectional view according to a second embodiment variant of the present disclosure with a spacer disk,

FIG. 3 shows a third embodiment variant of the present disclosure with pipe collars,

FIG. 4 shows a cross-sectional view showing the radial signal line in an at least partially circumferential configuration according to an embodiment of the present disclosure, and

FIG. 5 shows a cross-sectional view showing two radial signal lines in an at least partially circumferential configuration according to an embodiment of the present disclosure.

### DETAILED DESCRIPTION

In the figures, the same reference numerals are used for same or similar components, although a repeated description is omitted for reasons of simplicity.

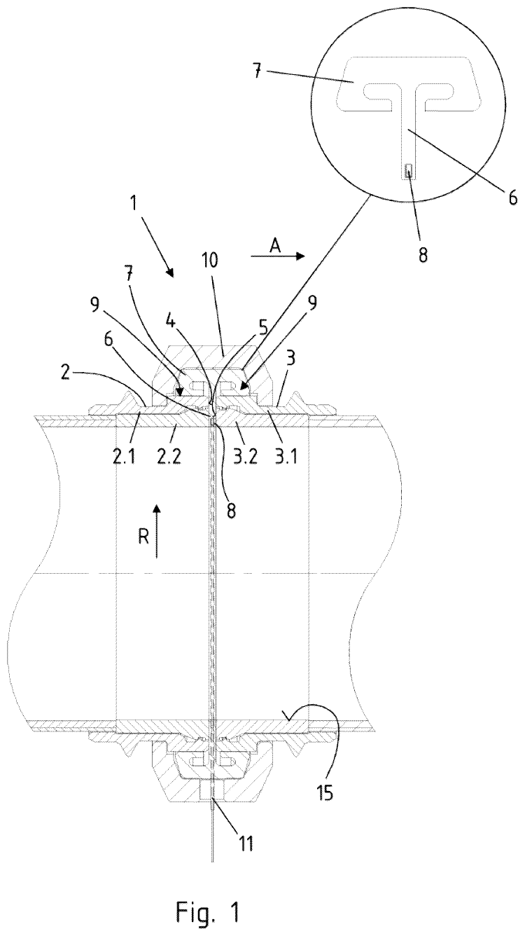

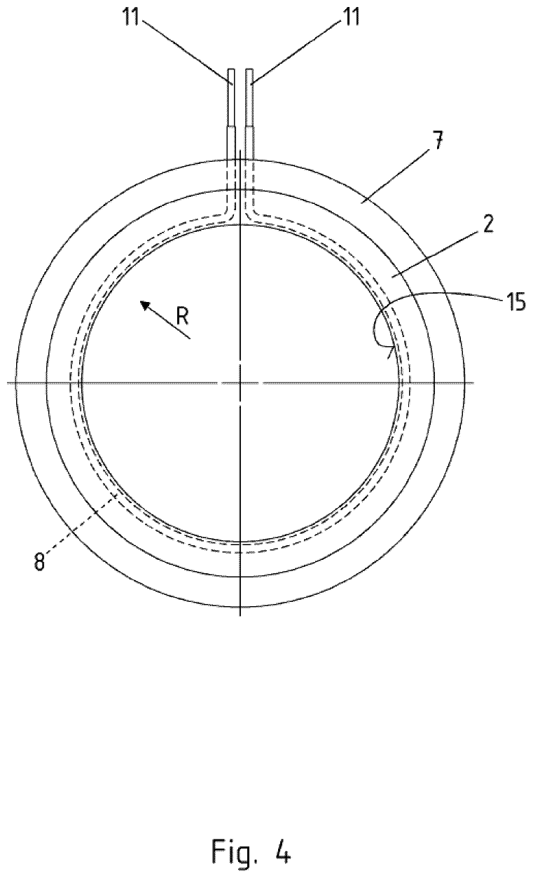

FIG. 1 shows a solids-conveying pipe assembly according to the present disclosure in which two pipe components 2, 3 are coupled together. The pipe components 2, 3 themselves are designed in two layers with an inner layer 2.1, 3.1 and an outer layer 2.2, 3.2. The pipe components 2, 3 do not lie directly against each other with respective end faces 4. Here, a web 6 projecting inwards in the radial direction is incorporated. The web 6 is formed in one piece and made of the same material with an externally arranged seal 7. A signal line 8 is incorporated into the web 6 and, as shown in FIG. 4, is designed with an at least partially circumferential configuration. The seal 7 overlaps on the outside in the axial direction the ends 9 of the pipe components 2, 3. On the outside, the seal 7 and the ends 9 are in turn encompassed by a pipe clamp 10, which connects the pipe components 2, 3 to one another in the axial direction. By replacing the seal 7, an existing solids-conveying pipe assembly 1 is able to be retrofitted with the signal line 8 according to the present disclosure. A connecting line 11 of the signal line 8 then projects radially outwards and is able to lead to an evaluation unit not shown in detail, for example, wirelessly or wired. The evaluation unit is also able to be integrated directly into the pipe clamp 10 and then output a signal about the state of wear via wireless transmission or NFC tag.

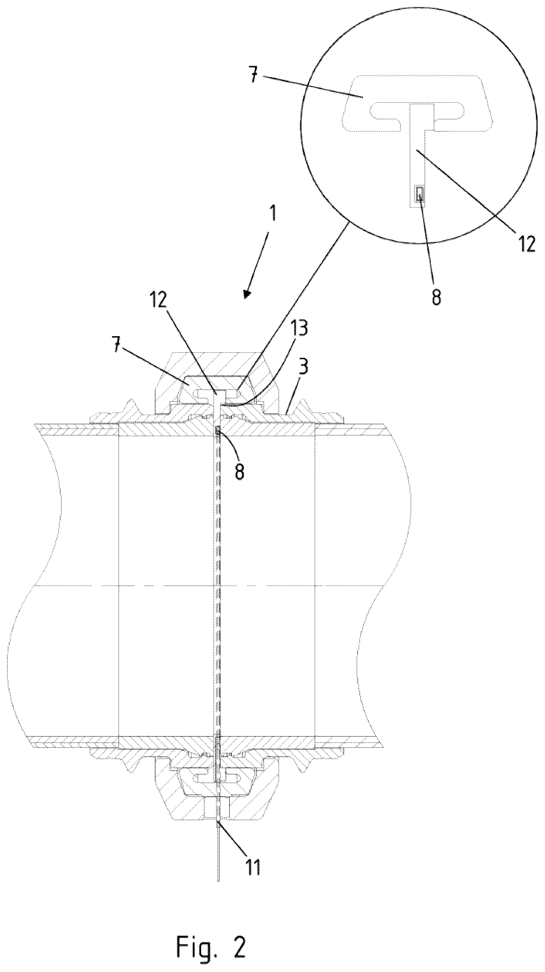

FIG. 2 shows an alternative embodiment variant of the solids-conveying pipe assembly 1 according to the present disclosure. Here, the web 6 is not formed in one piece and made of the same material as the seal 7 itself. The web 6 is designed as a spacer disk 12. The signal line 8 is cast into the spacer disk 12 itself and is designed to be at least radially circumferential. In order for the spacer disk 12 to be correctly positioned, the spacer disk 12 has an undercut 13 so as to overlap the pipe component 3 shown on the right in the image plane, at least in sections, radially on the outside and in the axial direction A. Thus, the spacer disk 12 is correctly positioned, which in turn enables correct positioning of the signal line 8 in the radial direction R.

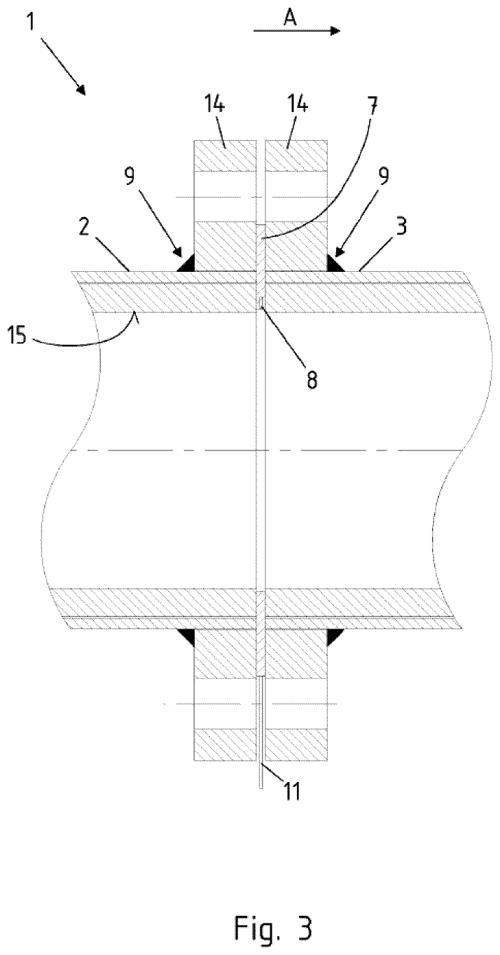

FIG. 3 shows an alternative embodiment variant. Here, the ends 9 of the pipe components 2, 3 are each formed with a flange 14. The flanges 14 are penetrated by screw bolts (not shown in detail) so that the pipe components 2, 3 are moved towards each other in the axial direction. A sealing disk in the form of a seal 7 is incorporated between the pipe components 2, 3. In the seal 7 itself, the signal line 8 is incorporated in a partially circumferential configuration.

FIG. 4 shows a longitudinal sectional view. Here, the radial, at least partially circumferential signal line 8 is shown. This is cast in a position in the web 6 of the seal 7 or the spacer disk 12 with respect to the radial direction. Compared to an inner lateral surface 15 of the pipe component 2, 3, the signal line 8 is offset outwardly with respect to the image plane. Thus, first the inner lateral surface 15 of the pipe component 2, 3 wears out, then a part of the spacer disk 12 or the web 6 until the signal line 8 is reached by the abrasive wear. At this point at the latest, a critical state of wear is reached or a signal is issued.

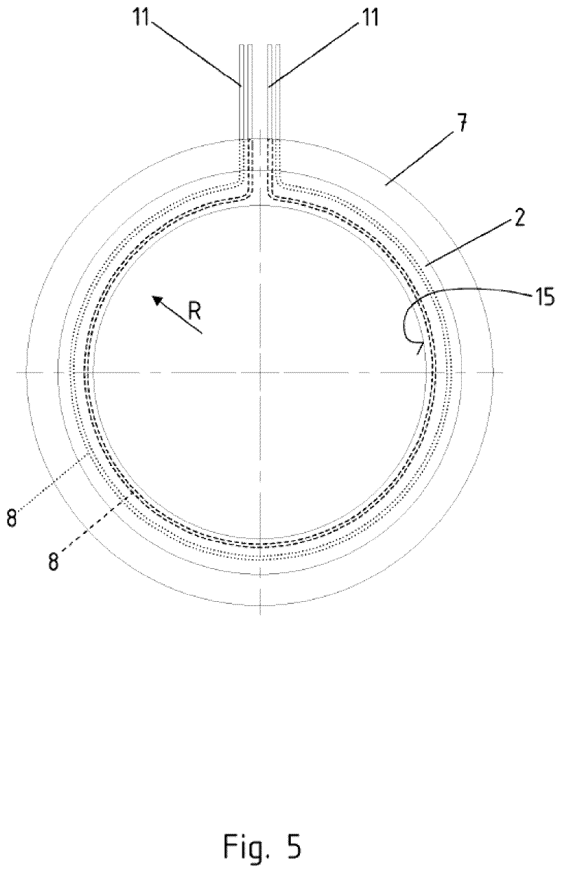

FIG. 5 shows a longitudinal sectional view of an alternative embodiment variant of the present disclosure. Here, two partially circumferential signal lines 8 are shown. The internal signal line 8 is arranged analogously to FIG. 4. The external signal line 8 is incorporated between the pipe components 2, 3 at a radial distance from the internal signal line 8. If the internal signal line 8 is destroyed by abrasive wear, the external signal line 8 forms a further control level. The external signal line 8 also emits a signal when a critical wear condition is reached. In this way, the progressive wear of the pipe components 2, 3 are able to be closely monitored.

The foregoing description of some embodiments of the disclosure has been presented for purposes of illustration and description. The description is not intended to be exhaustive or to limit the disclosure to the precise form disclosed, and modifications and variations are possible in light of the above teachings. The specifically described embodiments explain the principles and practical applications to enable one ordinarily skilled in the art to utilize various embodiments and with various modifications as are suited to the particular use contemplated. Various changes, substitutions and alterations can be made hereto without departing from the spirit and scope of the disclosure.

1-10. (canceled)

11. A solids-conveying pipe assembly, comprising:
at least two pipe components which are coupled together at end faces thereof;
a signal line configured to provide information regarding a state of wear of the at least two pipe components; and
a seal or a spacer disk, wherein
the seal or the spacer disk is incorporated between the end faces of the at least two pipe components,
the signal line is arranged in an at least radial and partially circumferential configuration in the seal or in the spacer disk,
the signal line is at least partially set back outwardly, in a radial direction, behind an inner lateral surface of at least one pipe component of the at least two pipe components,
the at least two pipe components overlap one another at least in sections by the seal in an axial direction on respective outer lateral surfaces thereof, or the spacer disc partially overlaps at least one pipe component of the at least two pipe components radially on the respective outer lateral surfaces thereof in the axial direction,
the seal or the spacer disc has a web protruding inwards in the radial direction,
the web is arranged between the end faces of the at least two pipe components, and
the signal line is cast in the web.

12. The solids-conveying pipe assembly according to claim 11, wherein
the at least two pipe components have respective flanges at the end faces thereof, and
the at least two pipe components are coupled to one another by incorporating the seal, which is a flat seal, between the flanges.

13. The solids-conveying pipe assembly according to claim 11, wherein
each of the at least two pipe components comprises two layers.

14. The solids-conveying pipe assembly according to claim 11, wherein
the signal line is an electrically conductive body, and
the electrically conductive body is enclosed on all sides by the seal or a material of the spacer disk.

15. The solids-conveying pipe assembly according to claim 11, wherein
the signal line is an optical conductor.

16. The solids-conveying pipe assembly according to claim 11, wherein
the at least two pipe components comprise more than three pipe components which are coupled to one another at at least two coupling points, and
a respective signal line is arranged at each coupling point of the at least two coupling points.

17. The solids-conveying pipe assembly according to claim 11, wherein
at least two signal lines are incorporated between the at least two pipe components at a distance from one another in the radial direction.
